(19) United States
(12) Patent Application Publication
(10) Pub. No.: US 2026/0365046 A1
(43) Pub. Date: Nov. 19, 2026

(54) SYSTEM AND METHOD FOR CONTROLLING SOC OF BATTERY OF HYDROGEN ELECTRIC VEHICLE

(71) Applicants: Hyundai Motor Company, Seoul (KR); Kia Corporation, Seoul (KR)

(72) Inventors: Soon Oh Kwon, Hwaseong-si (KR); Sang Beom Lee, Hwaseong-si (KR); Young Woo Jung, Hwaseong-si (KR); Jong Bin Kang, Hwaseong-si (KR)

(73) Assignees: Hyundai Motor Company, Seoul (KR); KIA Corporation, Seoul (KR)

(21) Appl. No.: 19/325,282

(22) Filed: Sep. 10, 2025

(30) Foreign Application Priority Data
May 14, 2025 (KR) 10-2025-0062813

(51) Int. Cl. B60L 50/75; B60L 58/13; B60L 58/31; B60L 58/40

(52) U.S. Cl. CPC B60L 50/75; B60L 58/13; B60L 58/31; B60L 58/40; B60L 2240/486

(57) ABSTRACT

The present disclosure includes a control mode determination unit configured to monitor a current SoC for required vehicle output in a hybrid driving mode, compare the current SoC with a target SoC, and determine variable stack output of a hydrogen fuel cell for charge control or discharge control, and a forced charging determination unit configured to monitor a current SoC for required vehicle output in an EV driving mode, compare the current SoC with a target SoC, control on/off of the hydrogen fuel cell for forced charging in response to a set driving condition satisfied, and determine variable stack output of the hydrogen fuel cell for efficiency priority control or charging priority control to follow a set SoC.

### CROSS-REFERENCE TO RELATED APPLICATION

This application claims, under 35 U.S.C. §119(a), the benefit of and priority to Korean Patent Application No. 10-2025-0062813 filed on May 14, 2025, the entire contents of which are incorporated herein by reference in its entirety.

### BACKGROUND

### Technical Field

The present disclosure relates to a system and method for controlling an SoC of a battery of a hydrogen electric vehicle. More particularly, it relates to a system and method for controlling an SoC of a battery of a hydrogen electric vehicle capable of improving fuel efficiency and driving range.

### Background Art

In recent years, the urgency surrounding the depletion of fossil fuels and the exacerbation of environmental pollution due to exhaust emissions has become increasingly pronounced around the world. As these issues escalate, the development and implementation of alternative energy sources have gained momentum as potentially effective solutions to combat global challenges, such as climate change and global warming. This shift towards renewable energy is not merely a reactionary measure, but is driven by an increasing recognition of the need for sustainable energy practices that minimize ecological footprints while meeting the energy demands of growing populations.

Various forms of alternative energy, including solar, wind, hydroelectric, and geothermal energy, are at the forefront. For example, research and technological advancements in these sectors are active, focusing on increasing energy efficiency, reducing costs, and enhancing the reliability of these energy sources. Researchers are collaborating to facilitate a transition to clean energy that aims to mitigate the effects of greenhouse gas emissions, thereby addressing both immediate environmental concerns and promoting long-term sustainability.

The automobile industry has increasingly focused its research efforts on the utilization of fuel cell systems as a vehicular power source, driven by their potential as cutting-edge power generation technology. Fuel cells are recognized for their remarkable power generation efficiency and their environmentally friendly characteristics, chiefly their lack of pollutant emissions during operation. This positions them as a compelling alternative to conventional power generation methods, which often rely on fossil fuels and produce significant amounts of emissions and other environmental pollutants. As the automotive sector seeks to reduce its carbon footprint and transition towards more sustainable energy solutions, the deployment of fuel cell technology presents a viable pathway to achieving these objectives while enhancing vehicle performance.

Moreover, the ongoing advancements in fuel cell technology—such as improvements in materials, cost reduction of production processes, and the development of hydrogen infrastructure—further bolster their viability as a dominant power source in future vehicle designs. The integration of fuel cell systems not only promises to advance the sustainability agenda of the automotive industry, but also supports the broader goals of energy transition and climate mitigation.

Fuel cells have garnered significant attention as vital components in the development of eco-friendly vehicles, particularly Fuel Cell Electric Vehicles (FCEVs). Fuel cells are electrochemical devices that convert the chemical energy of hydrogen and oxygen into electrical energy, typically within a fuel cell stack, which acts as the main energy production unit for vehicles. The generated electrical energy powers the vehicle’s motor, making it an environmentally friendly alternative to traditional internal combustion engines (ICEs). Fuel cells typically deliver an output voltage in a range of approximately -1 V to +1.2 V, which, while contributing to their eco-friendliness, presents challenges in terms of responsiveness to dynamic load changes. During high-acceleration scenarios, this reduction in voltage adversely impacts acceleration performance, as insufficient voltage limits the motor's power output.

Another critical challenge associated with fuel cells is the occurrence of voltage fluctuations due to the electrochemical nature of their operation. Rapid changes in load demand, such as during sudden acceleration, can lead to significant voltage fluctuations, which not only affect the immediate driving capabilities but also compromise long-term durability.

To surmount the limitations of fuel cells with respect to responsiveness, FCEVs have been designed with a hybrid strategy that incorporates high-voltage battery systems. For instance, the fuel cell serves as the primary energy source, while the battery acts as an auxiliary power source that provides supplemental energy when needed. This integration allows for optimized power management, where electrical energy generated by the fuel cell can be shared between the load and the battery, increasing system performance.

In situations of heightened power demand—such as rapid acceleration—the battery discharges energy to supplement the fuel cell output, a mechanism referred to as load demand response. This strategy is essential in maintaining an adequate power supply during moments of high output demand, thus ensuring effective vehicle operation. Moreover, enhancing fuel efficiency remains a fundamental objective for FCEVs. This can be achieved through the implementation of control strategies like SoC management to optimize the interaction between the battery and fuel cell components.

While fuel cells pose certain limitations regarding power delivery when compared to traditional ICEs, their integration with battery technology provides benefits. Thus, there is a need for improved vehicle performance and efficiency, particularly in scenarios involving high power demands, as well as robust system integration with battery technologies.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

An aspect of the present disclosure is to provide a system and method for controlling an SoC of a battery of a hydrogen electric vehicle having a hybrid structure including a hydrogen fuel cell and a high-voltage battery capable of increasing fuel efficiency and improving a driving range of the hydrogen electric vehicle to improve marketability of the hydrogen electric vehicle by enabling driving in an optimal efficiency region taking into account operation efficiency of a hydrogen fuel cell system and energy path loss of the high-voltage battery through an SoC control strategy for the high-voltage battery.

In one aspect, the present disclosure provides a system for controlling a state of charge (SoC) of a battery of a hydrogen electric vehicle, the system including a control mode determination unit configured to monitor a current SoC for required vehicle output in a hybrid driving mode, compare the current SoC with a target SoC, and determine variable stack output of a hydrogen fuel cell for charge control or discharge control, and a forced charging determination unit configured to monitor a current SoC for required vehicle output in an EV driving mode, compare the current SoC with a target SoC, control on/off of the hydrogen fuel cell for forced charging in response to a set driving condition satisfied, and determine variable stack output of the hydrogen fuel cell for efficiency priority control or charging priority control to follow a set SoC.

In embodiments, the forced charging determination unit includes a first forced charging determination unit configured to control on/off of the hydrogen fuel cell according to whether the hydrogen electric vehicle is in a Park gear or a Neutral gear so that efficiency priority control or charging priority control is performed, and a second forced charging determination unit configured to control on/off of the hydrogen fuel cell according to whether the hydrogen electric vehicle is in a Drive gear or a Reverse gear so that efficiency priority control or charging priority control is performed.

In embodiments, the first forced charging determination unit may perform a control operation to turn on the hydrogen fuel cell so that the current SoC reaches the set SoC set as a lowest SoC for turning on/off the hydrogen fuel cell by the efficiency priority control, and perform a control operation to turn off the hydrogen fuel cell based on the current SoC reaching the set SoC according to a first stack output amount.

In embodiments, the first forced charging determination unit may cause the efficiency priority control to be preemptively performed, and cause the charging priority control to be performed with a second stack output amount that is higher compared to a first stack output amount that is based on the current SoC being determined to continuously decreasing below the set SoC.

In embodiments, the first forced charging determination unit may perform a control operation to turn off the hydrogen fuel cell based on the current SoC reaching the set SoC in response to the charging priority control being performed with the second stack output amount.

In embodiments, the second forced charging determination unit may perform a control operation to turn on the hydrogen fuel cell so that the current SoC reaches the set SoC set as a lowest SoC for turning on/off the hydrogen fuel cell by the efficiency priority control, and perform a control operation to turn off the hydrogen fuel cell based on the current SoC reaching the set SoC according to a first stack output amount.

In embodiments, the second forced charging determination unit may cause the efficiency priority control to be preemptively performed, and cause the charging priority control to be performed with a second stack output amount that is higher compared to a first stack output amount that is based on the current SoC being determined to continuously decreasing below the set SoC.

In embodiments, the second forced charging determination unit may perform a control operation to turn off the hydrogen fuel cell based on the current SoC reaching the set SoC in response to the charging priority control being performed with the second stack output amount.

In embodiments, the control mode determination unit may compare the current SoC with the target SoC, and cause discharge control to be performed according to an efficiency line set as an optimal stack output amount for discharge compared to the required vehicle output according to the SoC based on the discharge control being required.

In embodiments, the control mode determination unit may compare the current SoC with the target SoC, and cause charge control to be performed according to an efficiency line set as an optimal stack output amount for discharge compared to the required vehicle output according to the SoC based on the charge control being required.

In another aspect, the present disclosure provides a method of controlling an SoC of a battery of a hydrogen electric vehicle, the method including a driving mode determination step of determining whether a vehicle state is a hybrid driving mode or an EV driving mode through operation of a hydrogen fuel cell, an SoC maintenance step of monitoring a current SoC for required vehicle output in response to determining that the vehicle state is the hybrid driving mode, comparing the current SoC with a target SoC, determining variable stack output of a hydrogen fuel cell for charge control or discharge control through a control mode determination unit, and performing SoC control with the determined stack output, and an SoC forced charging control step of monitoring a current SoC for required vehicle output in response to determining that the vehicle state is the EV mode, comparing the current SoC with a target SoC, controlling on/off of the hydrogen fuel cell for forced charging in response to a set driving condition satisfied, determining variable stack output of the hydrogen fuel cell for efficiency priority control or charging priority control to follow a set SoC through a forced charging determination unit, and performing SoC control with the determined stack output.

Here, when determining the variable stack output of the hydrogen fuel cell for efficiency priority control or charging priority control to follow the set SoC, the stack output amount having lower hydrogen consumption (g/kWh) per unit output at the same required output may be preset as an efficiency priority control criterion by considering the operation efficiency of the hydrogen fuel cell system and the energy path loss of the high-voltage battery to produce the unit output (kWh), and the stack output amount for charging priority control may be lower than the stack output amount for efficiency priority control in terms of hydrogen consumption (g/kWh) per unit output at the same required output.

In embodiments, the SoC forced charging control step includes a first forced charging determination step of controlling on/off of the hydrogen fuel cell according to whether the hydrogen electric vehicle is in a Park gear or a Neutral gear so that efficiency priority control or charging priority control is performed, and a second forced charging determination step of controlling on/off of the hydrogen fuel cell according to whether the hydrogen electric vehicle is in a Drive gear or a Reverse gear so that efficiency priority control or charging priority control is performed.

In embodiments, the first forced charging determination step includes performing a control operation to turn on the hydrogen fuel cell so that the current SoC reaches the set SoC set as a lowest SoC for turning on/off the hydrogen fuel cell by the efficiency priority control, and performing a control operation to turn off the hydrogen fuel cell based on the current SoC reaching the set SoC according to a first stack output amount.

In embodiments, the first forced charging determination step includes causing the efficiency priority control to be preemptively performed, and causing the charging priority control to be performed with a second stack output amount that is higher compared to a first stack output amount that is based on the current SoC being determined to continuously decreasing below the set SoC.

In embodiments, the first forced charging determination step includes performing a control operation to turn off the hydrogen fuel cell based on the current SoC reaching the set SoC in response to the charging priority control being performed with the second stack output amount.

In embodiments, the second forced charging determination step includes performing a control operation to turn on the hydrogen fuel cell so that the current SoC reaches the set SoC set as a lowest SoC for turning on/off the hydrogen fuel cell by the efficiency priority control, and performing a control operation to turn off the hydrogen fuel cell based on the current SoC reaching the set SoC according to a first stack output amount.

In embodiments, the second forced charging determination step includes causing the efficiency priority control to be preemptively performed, and causing the charging priority control to be performed with a second stack output amount that is higher compared to a first stack output amount that is based on the current SoC being determined to continuously decreasing below the set SoC.

In embodiments, the second forced charging determination step includes performing a control operation to turn off the hydrogen fuel cell based on the current SoC reaching the set SoC in response to the charging priority control being performed with the second stack output amount.

In embodiments, the SoC maintenance step includes comparing the current SoC with the target SoC, and causing discharge control to be performed according to an efficiency line set as an optimal stack output amount for discharge compared to the required vehicle output according to the SoC based on the discharge control being required.

In embodiments, the SoC maintenance step includes comparing the current SoC with the target SoC, and causing charge control to be performed according to an efficiency line set as an optimal stack output amount for discharge compared to the required vehicle output according to the SoC based on the charge control being required.

Other aspects and embodiments of the disclosure are discussed infra.

It is understood that the term "vehicle" or "vehicular" or other similar terms as used herein is inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram illustrating a configuration of a system for controlling an SoC of a battery of a hydrogen electric vehicle according to an embodiment of the present disclosure;

FIG. 2 is a diagram illustrating a hybrid driving region and an EV driving region for the system for controlling the SoC of the battery of the hydrogen electric vehicle according to an embodiment of the present disclosure;

FIG. 3 is a diagram illustrating target SoC discharge compensation for the system for controlling the SoC of the battery of the hydrogen electric vehicle according to an embodiment of the present disclosure;

FIG. 4 is a diagram illustrating target SoC charge compensation for the system for controlling the SoC of the battery of the hydrogen electric vehicle according to an embodiment of the present disclosure;

FIG. 5 is a diagram illustrating a first embodiment of efficiency priority control for the system for controlling the SoC of the battery of the hydrogen electric vehicle according to an embodiment of the present disclosure;

FIG. 6 is a diagram illustrating a first embodiment of output priority control for the system for controlling the SoC of the battery of the hydrogen electric vehicle according to an embodiment of the present disclosure;

FIG. 7 is a diagram illustrating a second embodiment of efficiency priority control for the system for controlling the SoC of the battery of the hydrogen electric vehicle according to an embodiment of the present disclosure;

FIG. 8 is a diagram illustrating a second embodiment of output priority control for the system for controlling the SoC of the battery of the hydrogen electric vehicle according to an embodiment of the present disclosure; and

FIG. 9 is a diagram sequentially illustrating a method of controlling the SoC of the battery of the hydrogen electric vehicle according to another embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, embodiments according to the present disclosure will be described in detail with reference to the attached drawings.

Advantages and features of the present disclosure and a method of achieving the advantages and features will become clear with reference to the embodiments described in detail below together with the attached drawings.

However, the present disclosure is not limited to the embodiments disclosed below and may be implemented in various different forms, the present embodiments are provided only to make the present disclosure complete and to fully inform a person having ordinary skill in the art to which the present disclosure pertains of the scope of the invention, and the present disclosure is defined only by the scope of the claims.

In addition, when describing the present disclosure, when it is determined that related public notice technologies, etc. may obscure the main point of the present disclosure, a detailed explanation thereof will be omitted.

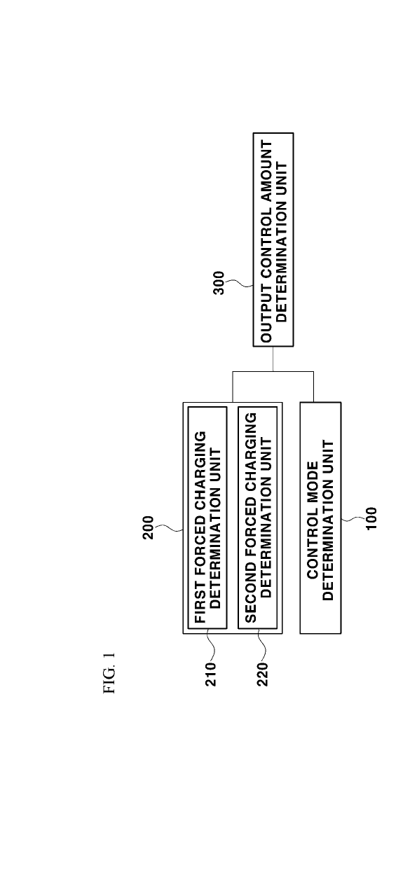

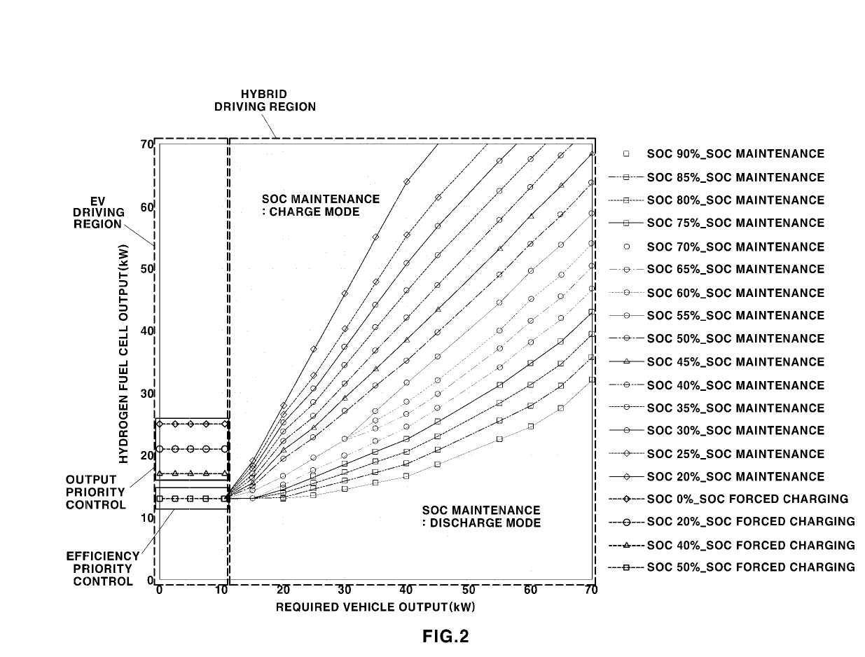

FIG. 1 is a diagram illustrating a configuration of a system for controlling an SoC of a battery of a hydrogen electric vehicle according to an embodiment of the present disclosure, and FIG. 2 is a diagram illustrating a hybrid driving region and an EV driving region for the system for controlling the SoC of the battery of the hydrogen electric vehicle according to an embodiment of the present disclosure.

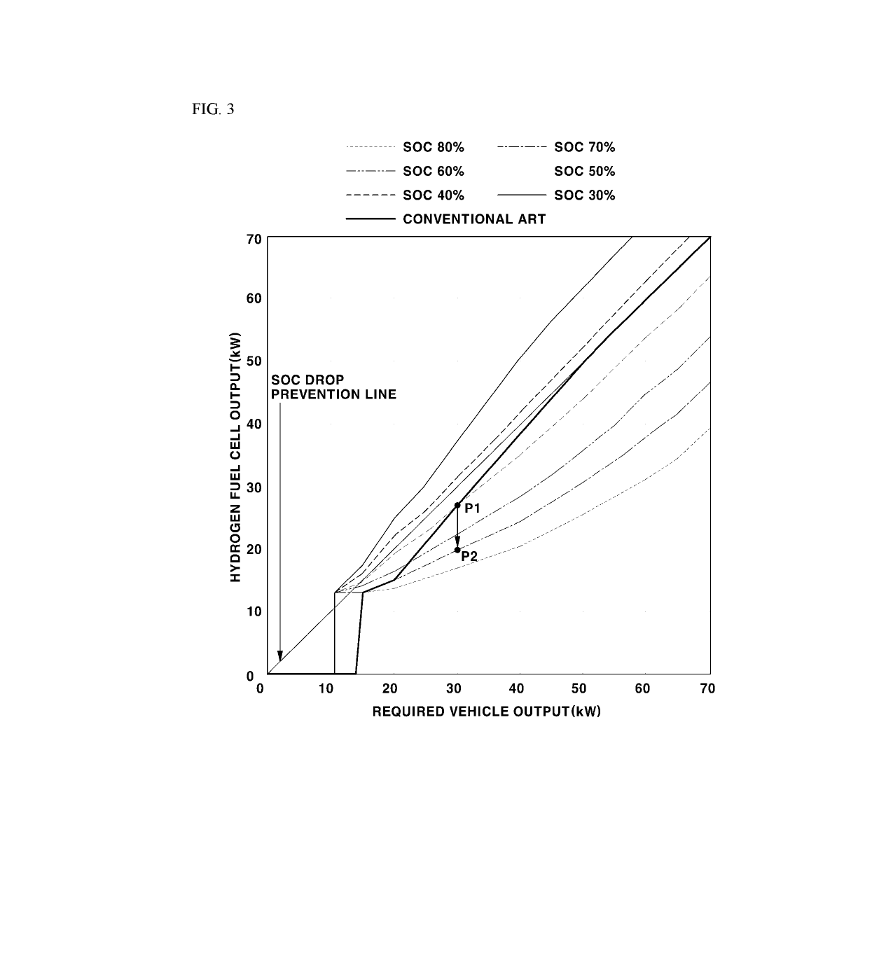

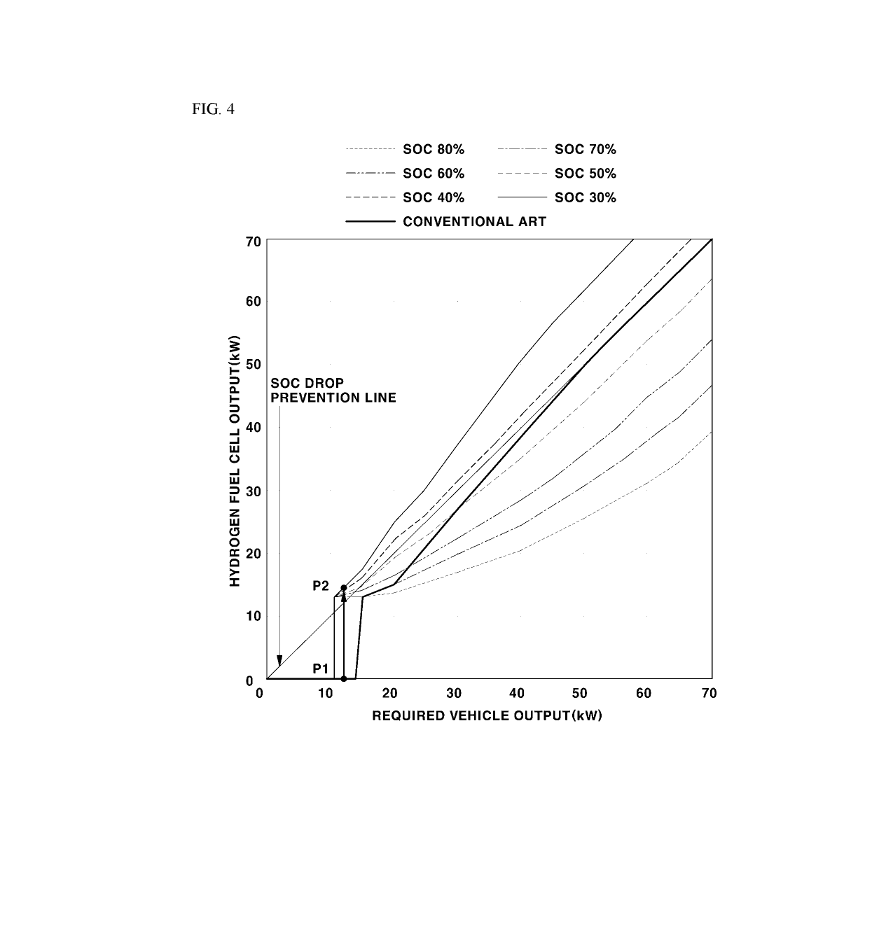

In addition, FIG. 3 is a diagram illustrating target SoC discharge compensation for the system for controlling the SoC of the battery of the hydrogen electric vehicle according to an embodiment of the present disclosure, and FIG. 4 is a diagram illustrating target SoC charge compensation for the system for controlling the SoC of the battery of the hydrogen electric vehicle according to an embodiment of the present disclosure.

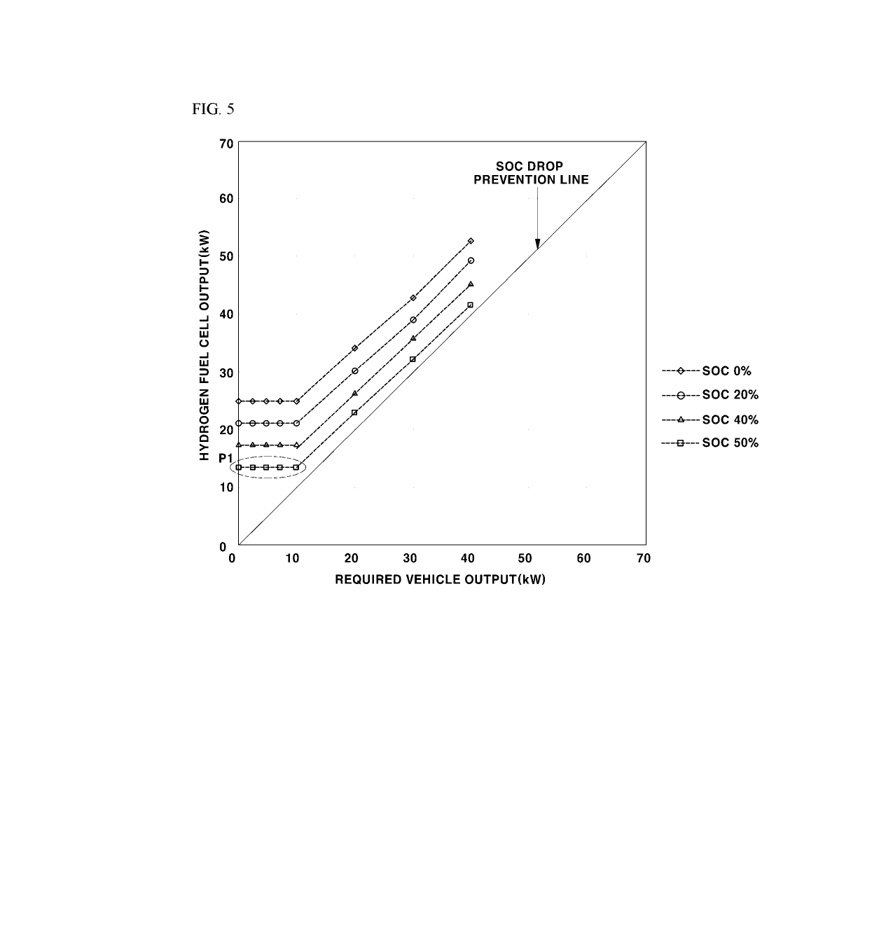

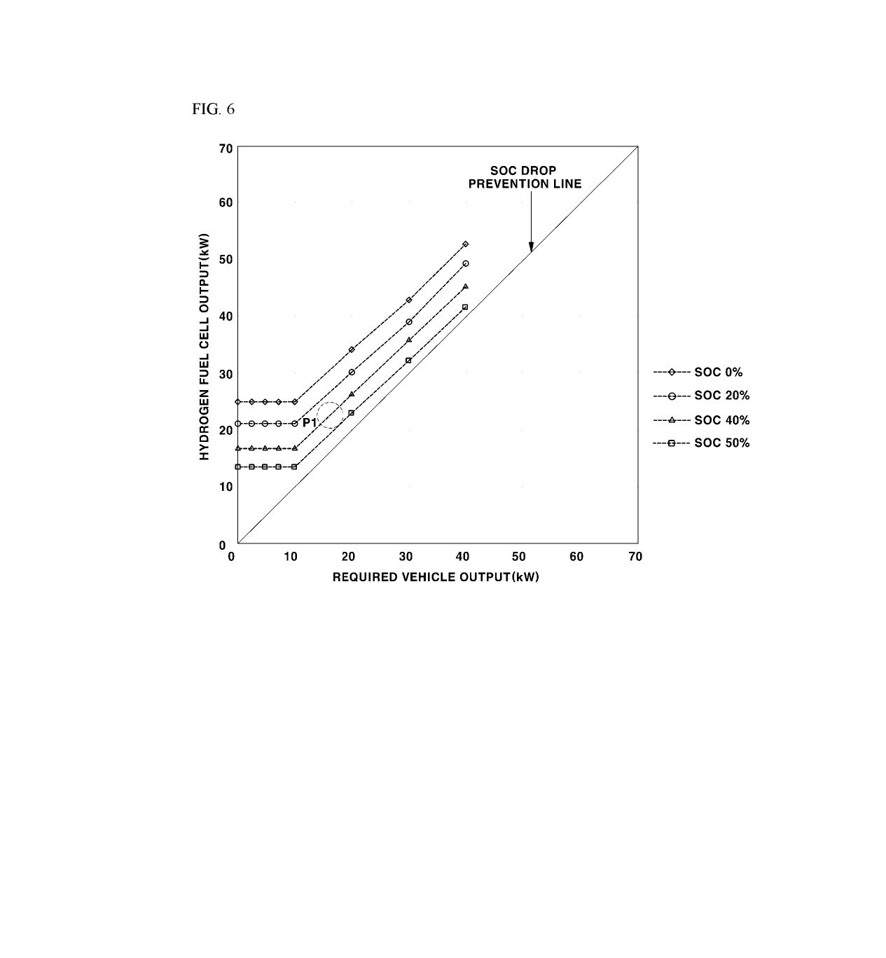

In addition, FIG. 5 is a diagram illustrating a first embodiment of efficiency priority control for the system for controlling the SoC of the battery of the hydrogen electric vehicle according to an embodiment of the present disclosure, and FIG. 6 is a diagram illustrating a first embodiment of output priority control for the system for controlling the SoC of the battery of the hydrogen electric vehicle according to an embodiment of the present disclosure.

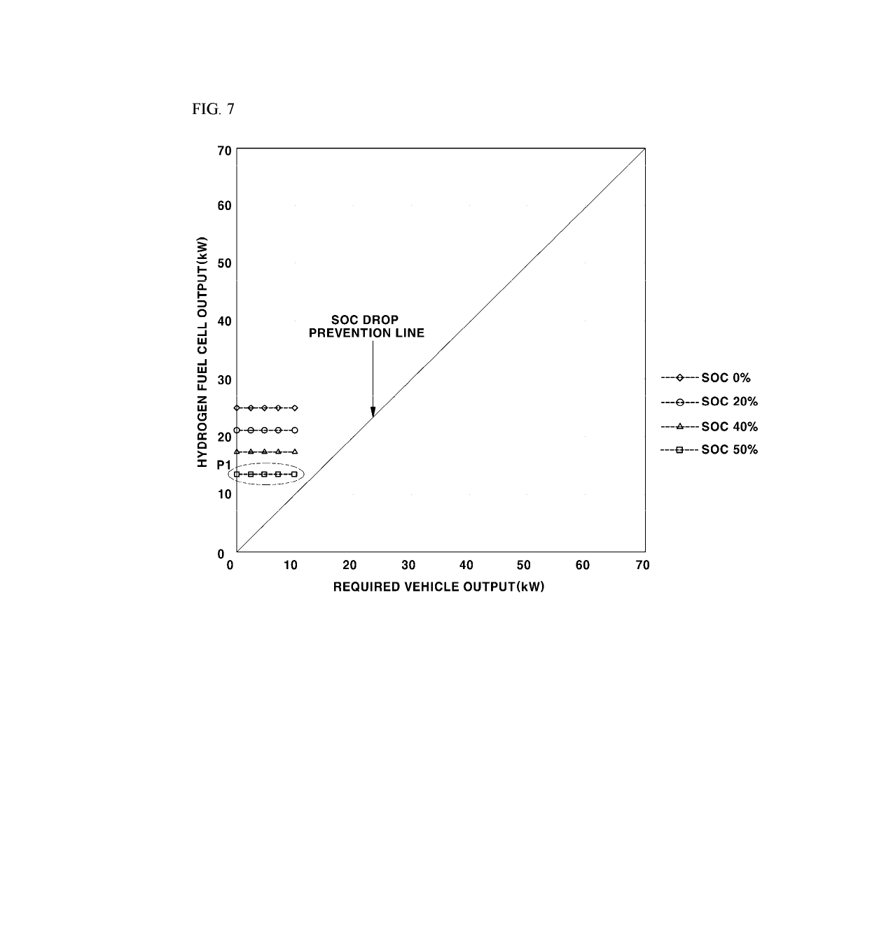

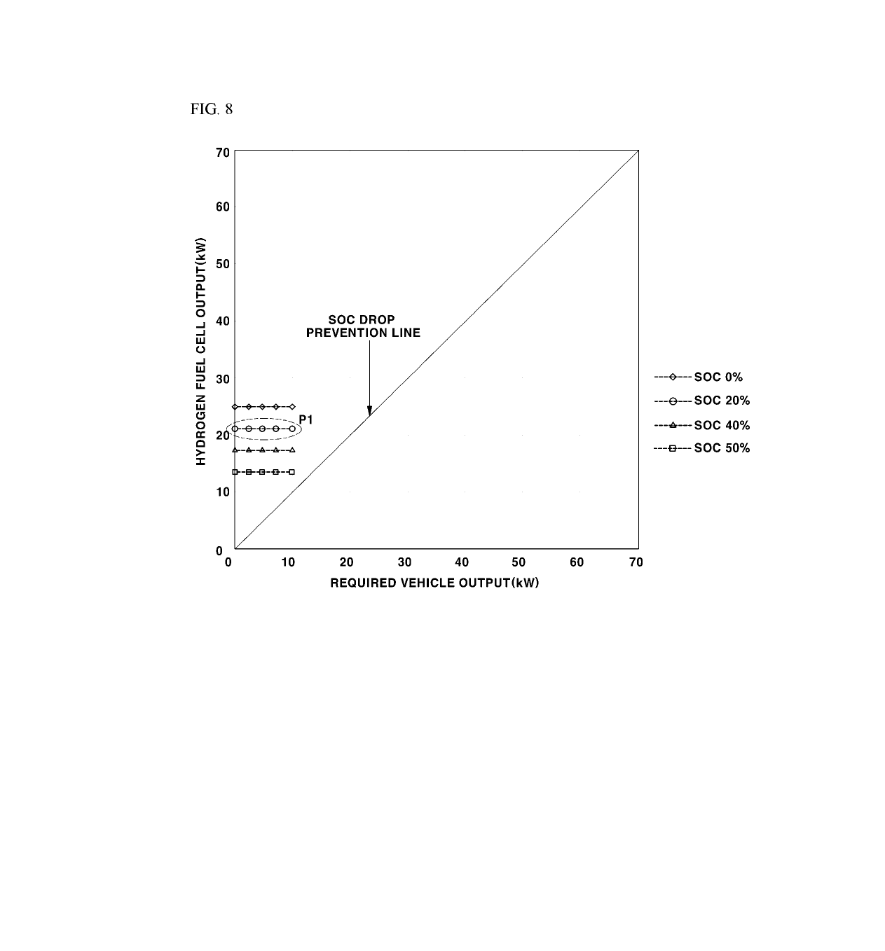

In addition, FIG. 7 is a diagram illustrating a second embodiment of efficiency priority control for the system for controlling the SoC of the battery of the hydrogen electric vehicle according to an embodiment of the present disclosure, and FIG. 8 is a diagram illustrating a second embodiment of output priority control for the system for controlling the SoC of the battery of the hydrogen electric vehicle according to an embodiment of the present disclosure.

A hydrogen electric vehicle having a hybrid structure needs to respond to total output as the sum of hydrogen fuel cell output and high-voltage battery input/output for output required by the vehicle, and at the same time, high-voltage battery target SoC convergence control needs to be performed. In this instance, efficiency of a hydrogen fuel cell system and path loss according to energy input/output of a high-voltage battery vary depending on the output region and occur in a complex manner.

When the output of the hydrogen fuel cell is variably controlled from this perspective, the output of the hydrogen fuel cell may be controlled in an optimal efficiency region that takes into account the efficiency of the hydrogen fuel cell system and the path loss according to the energy input/output of the high-voltage battery.

To this end, as illustrated in FIG. 1, the system for controlling the SoC of the battery of the hydrogen electric vehicle according to the present embodiment includes a control mode determination unit 100 and a forced charging determination unit 200.

In a hybrid driving mode, the control mode determination unit 100 monitors a current SoC for the vehicle required output, compares a target SoC with the current SoC, and determines variable stack output of the hydrogen fuel cell for charge control or discharge control.

That is, when operating the hydrogen fuel cell and the high-voltage battery in a hybrid mode, the control mode determination unit 100 variably controls output of the hydrogen fuel cell to enable operation in an optimal efficiency region by considering the efficiency of the hydrogen fuel cell system and the energy path loss of the high-voltage battery.

Referring to FIG. 2, in the hybrid driving region, in controlling output of the hybrid fuel cell to the battery for SoC maintenance, control is performed in a charge mode when a required vehicle output is less than a stack output, and control is performed in a discharge mode when the required vehicle output is greater than the stack output. The control mode determination unit 100 determines a variable stack output through an output control amount determination unit 300 by distinguishing between the charge mode and the discharge mode as described above, thereby enabling SoC output control.

The control mode determination unit 100 compares the set target SoC with the current SoC, and when discharge control is required based on a difference therebetween, discharge control is performed based on a predetermined efficiency line determined as an optimal stack output amount for discharge compared to a required vehicle output according to the SoC through the output control amount determination unit 300.

In other words, for example, when accelerating in Drive gear, the required vehicle output is 30 kW, and when operation is currently performed in an SoC 70% section, battery discharge control is required since the current SoC is 10% higher than the target SoC set to 60%.

In this instance, as illustrated in FIG. 3, even though efficiency for discharge control has not been considered, and hydrogen fuel cell output control according to P1 has been performed to estimate a SoC drop prevention line at a required vehicle output of 30 kW in the past, in the present embodiment, when the required vehicle output is 30 kW and the current operation is in the SoC 70% section, the hydrogen fuel cell output according to P2 corresponding to the required vehicle output of 30 kW is variably controlled within an efficiency line determined as the optimal stack output amount at the SoC of 70% through the output control amount determination unit 300, and at the same time, control for battery SoC discharge is performed.

In addition, the control mode determination unit 100 compares the set target SoC with the current SoC, and when charge control is required based on a difference therebetween, the output control amount determination unit 300 performs charge control according to a predetermined efficiency line determined as the optimal stack output amount for charging compared to the required vehicle output according to the SoC.

Here, when setting the optimal stack output for charging/discharging compared to the required vehicle output, a stack output amount having low hydrogen consumption (g/kWh) per unit output at the same required output is used as the standard, considering the operation efficiency of the hydrogen fuel cell system and the energy path loss of the high-voltage battery to produce the unit output (kWh), and when performing charge control or discharge control, a stack output amount having a low hydrogen consumption (g/kWh) per unit output at the same required output may be set in advance.

For example, in the past, the required vehicle output was 13 kW during constant speed driving, and when currently operating in an SoC 40% section, battery charge control is required since the current SoC is 20% lower than the target SoC set to 60%.

In this instance, as illustrated in FIG. 4, even though efficiency of stack operation has not been considered and control has been performed in an EV driving mode according to P1 as in the above-described discharge control in the past, in the present embodiment, when the required vehicle output is 30 kW and the current operation is in the SoC 40% section, the hydrogen fuel cell output according to P2 corresponding to the required vehicle output of 30 kW is variably controlled within an efficiency line set as the optimal stack output amount at the SoC of 40% through the output control amount determination unit 300, and at the same time, control for battery SoC charge is performed.

Here, as described above, in performing charge control or discharge control, for variable control of the stack output amount, the efficiency line determined through the output control amount determination unit 300 may be preset as an optimal stack output amount compared to the required vehicle output amount according to different SoC states, and each may be applied in a predetermined line form as shown in FIGS. 3 and 4.

Meanwhile, the forced charging determination unit 200 monitors the current SoC for the required vehicle output in the EV driving mode, compares the target SoC with the current SoC, and controls on/off of the hydrogen fuel cell for forced charging as the difference satisfies a set driving condition.

In embodiments, the forced charging determination unit 200 determines whether to perform forced charging based on the difference between the target SoC and the current SoC, and determines the variable stack output of the hydrogen fuel cell for efficiency priority control or charging priority control to follow the set SoC through the output control amount determination unit 300.

To this end, the forced charging determination unit 200 includes a first forced charging determination unit 210 and a second forced charging determination unit 220.

The first forced charging determination unit 210 controls on/off of the hydrogen fuel cell depending on whether the vehicle is in Park or Neutral gear, so that efficiency priority control or charging priority control is performed.

The first forced charging determination unit 210 performs a control operation to turn on the hydrogen fuel cell so that the current SoC reaches the set SoC, which is set as the lowest SoC for turning on/off the hydrogen fuel cell, through efficiency priority control, and performs a control operation to turn off the hydrogen fuel cell when the current SoC reaches the set SoC according to a first stack output amount.

That is, to compensate for a decrease in battery SoC when driving in the EV mode with the vehicle in Park or Neutral gear, the first forced charging determination unit 210 performs a control operation to temporarily turn on the hydrogen fuel cell and accordingly variably controls the output of the hydrogen fuel cell in the optimal efficiency line.

For example, the first forced charging determination unit 210 variably controls the hydrogen fuel cell output to reach a set SoC of 50% corresponding to P1 before entering the hybrid driving region in the EV driving region, as shown in FIG. 5, when the vehicle is stopped for several minutes to several hours while idling in Park in summer, with the A/C running, and when the set SoC is reached, the control is terminated by turning off the hydrogen fuel cell.

In the past, no output has been generated due to non-operation of the hydrogen fuel cell in the EV driving region, but in the present embodiment, a control operation is performed to turn on the hydrogen fuel cell so that a predetermined stack output amount is generated at a level that reaches a set SoC. In this way, the variable stack output amount at this time may be compensated according to a decrease in the battery SoC.

In addition, in preemptively performing efficiency priority control as described above, when determining that the current SoC is continuously decreasing below the set SoC, the first forced charging determination unit 210 performs the output priority control with a second stack output amount that is higher than the first stack output amount (see FIG. 2).

For example, when a high-load output withdrawal condition such as V2L operation occurs in a state in which hydrogen fuel cell output variable control has started with SoC 50% optimal efficiency line to compensate for the target SoC for the decrease in battery SoC as described above in driving in the EV mode in Park or Neutral gear, the SoC continues to decline due to insufficient SoC compensation output at a start point of efficiency priority control of SoC 50%, and the SoC line moves from 50% to 40%. Accordingly, as illustrated in FIG. 6, the first forced charging determination unit 210 performs control in a region outside an optimal efficiency region corresponding to P1 to achieve charging priority hydrogen fuel cell output.

Here, when the battery SoC, which has dropped to 40%, is raised to 50% by output variable control, the first forced charging determination unit 210 varies the hydrogen fuel cell output to follow the SoC 50% optimal efficiency line, and when the target SoC is reached, the control is terminated by turning off the hydrogen fuel cell.

Meanwhile, the second forced charging determination unit 220 performs a control operation to turn on the hydrogen fuel cell so that the current SoC reaches the set SoC, which is set as the lowest SoC for turning on/off the hydrogen fuel cell, through efficiency priority control, and performs a control operation to turn off the hydrogen fuel cell when the current SoC reaches the set SoC according to the first stack output amount.

That is, the second forced charging determination unit 220 performs a control operation to temporarily turn on the hydrogen fuel cell to compensate for the decrease in battery SoC during driving in the EV mode in Drive or Reverse, for example, during driving such as low-speed creep driving, accordingly, variably controls the hydrogen fuel cell output in the optimal efficiency line, for example, variably controls the hydrogen fuel cell output corresponding to P1 to reach the set SoC of 50%, and ends the control by turning off the hydrogen fuel cell when the set SoC is reached.

In addition, in preemptively performing efficiency priority control as described above, when determining that the current SoC is continuously decreasing below the set SoC, the second forced charging determination unit 220 performs charging priority control with the second stack output amount that is higher than the first stack output amount (see FIG. 2).

For example, the second forced charging determination unit 220 continuously drives the vehicle in a high-load mode in Drive or Reverse, and when the vehicle stops in a state in which the battery SoC continues to drop, that is, when the battery SoC drops from the target SoC of 60% to 20%, 40% of the SoC needs to be compensated. Therefore, as illustrated in FIG. 8, variable control of the hydrogen fuel cell output starts based on a line corresponding to P1 higher than that during output priority control of the first forced charging determination unit 210 by turning on the hydrogen fuel cell.

In this instance, similarly to the first forced charging determination unit 210, the second forced charging determination unit 220 variably controls the hydrogen fuel cell output to reach the set SoC of 50%, and ends the control by turning off the hydrogen fuel cell when the set SoC is reached.

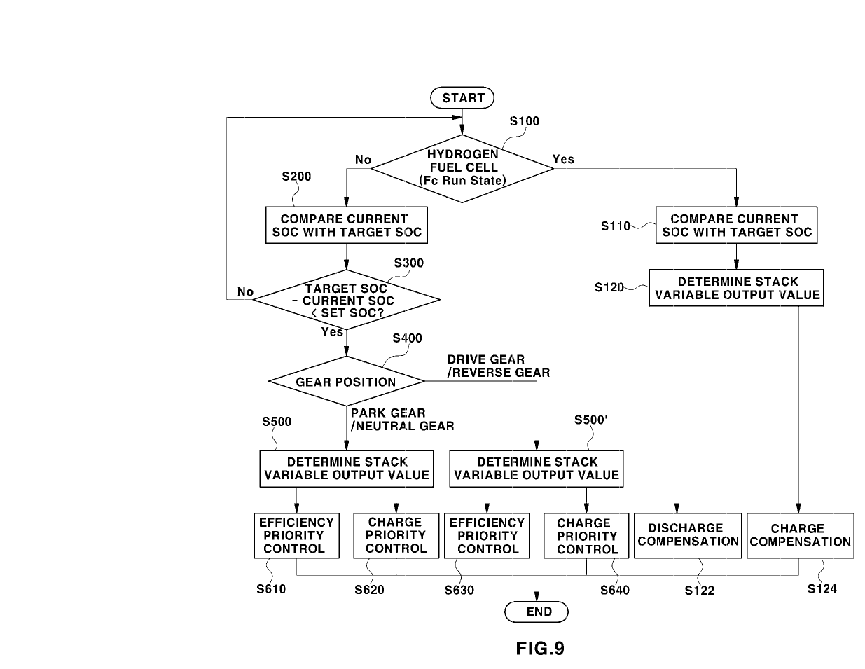

FIG. 9 is a diagram sequentially illustrating a method of controlling the SoC of the battery of the hydrogen electric vehicle according to another embodiment of the present disclosure.

As illustrated in FIG. 9, the method of controlling the SoC of the battery of the hydrogen electric vehicle according to the present embodiment will be sequentially described as follows.

First, through an operation of the hydrogen fuel cell, it is determined whether a vehicle state is the hybrid driving mode or the EV driving mode (S100).

In other words, when the hydrogen fuel cell is in operation, the battery is determined to be in the hybrid driving mode including the charge mode and the discharge mode, and when the hydrogen fuel cell is not in operation, the battery is determined to be in the EV driving mode including an SoC forced charge mode.

Here, when the battery is determined to be in the hybrid driving mode, the current SoC for the required vehicle output is monitored, the target SoC and the current SoC are compared (S110), and variable stack output of the hydrogen fuel cell for charge control or discharge control is determined based on a difference therebetween (S120).

That is, when the hydrogen fuel cell and the high-voltage battery are driven in the hybrid mode, the output of the hydrogen fuel cell is variably controlled so that operation is performed in the optimal efficiency range by considering the hydrogen fuel cell system efficiency and the energy path loss of the high-voltage battery.

Referring to FIG. 2, in the hybrid driving region, in controlling the hydrogen fuel cell output for the battery for SoC maintenance, the output is controlled in the charge mode when the required vehicle output is less than the stack output, and the output is controlled in the discharge mode when the required vehicle output is greater than the stack output. As described above, variable stack output is determined by distinguishing between the charge mode and the discharge mode, and SoC output control is achieved in this way.

Here, the set target SoC and the current SoC are compared, and when discharge control is required based on a difference therebetween, discharge control is performed according to an efficiency line set as the optimal stack output for discharge compared to the required vehicle output according to the SoC (S122).

In other words, previously, for example, when accelerating in Drive gear, the required vehicle output is 30 kW, and the vehicle is currently operating in an SoC 70% section, battery discharge control is required since the current SoC is 10% higher than the target SoC set to 60%.

In this instance, previously, hydrogen fuel cell output control has been performed according to P1 to estimate an SoC drop prevention line at the required vehicle output of 30 kW without considering efficiency for discharge control. However, in the present embodiment, when the required vehicle output is 30 kW and operation is performed in the current SoC 70% section, hydrogen fuel cell output is variably controlled according to P2 corresponding to the required vehicle output of 30 kW within an efficiency line determined by the optimal stack output at SoC 70%, and control for battery SoC discharge is performed (see FIG. 3).

In addition, when the set target SoC is compared with the current SoC, and charge control is required, charge control is performed according to an efficiency line set as the optimal stack output for charging compared to the required vehicle output according to the SoC (S124).

In other words, for example, in the conventional Drive gear constant speed condition, when the required vehicle output is 13 kW, and operation is performed in the current SoC 40% section, battery charge control is required since the current SoC is 20% lower than the target SoC set to 60%.

In this instance, previously, as in the discharge control described above, the efficiency of stack operation has not been considered, and control has been performed in the EV driving mode according to P1. However, in the present embodiment, when the required vehicle output is 30 kW, and operation is performed in the current SoC 40% section, the hydrogen fuel cell output according to P2 corresponding to the required vehicle output of 30 kW is variably controlled within the efficiency line set as the optimal stack output amount at the SoC of 40% through the output control amount determination unit 300, and at the same time, control for battery SoC charging is performed (see FIG. 4).

In embodiments, as described above, in order to perform charge control or discharge control, for variable control of stack output amount, the efficiency line determined through the output control amount determination unit 300 may be preset as an optimal stack output amount compared to the required vehicle output amount according to different SoC states, and each may be applied in a predetermined line form as shown in FIGS. 3 and 4.

Meanwhile, when the EV mode is determined due to non-operation of the hydrogen fuel cell, the current SoC for the required vehicle output is monitored, the target SoC and the current SoC are compared (S200), and when a difference satisfies the set driving condition, that is, when the difference between the target SoC and the current SoC is determined to be less than the set SoC (S300), on/off of the hydrogen fuel cell for forced charging is controlled.

To this end, a gear position is preemptively checked (S400), and depending on whether the gear is Drive or Neutral, on/off of the hydrogen fuel cell is controlled to determine the stack variable output to compensate for the required vehicle output amount and the difference between the target SoC and the current SoC (S500). Accordingly, efficiency priority control or charging priority control is performed.

Here, when determining the variable stack output of the hydrogen fuel cell for efficiency priority control or charging priority control to follow the set SoC, the stack output amount having lower hydrogen consumption (g/kWh) per unit output at the same required output may be preset as an efficiency priority control criterion by considering the operation efficiency of the hydrogen fuel cell system and the energy path loss of the high-voltage battery to produce the unit output (kWh), and the stack output amount for charging priority control may be lower than the stack output amount for efficiency priority control in terms of hydrogen consumption (g/kWh) per unit output at the same required output.

In this way, efficiency priority control is preemptively implemented (S610), and by this efficiency priority control, a control operation is performed to turn on the hydrogen fuel cell so that the current SoC reaches the set SoC, which is set as the lowest SoC for turning on/off the hydrogen fuel cell. When the current SoC reaches the set SoC according to the first stack output amount, a control operation is performed to turn off the hydrogen fuel cell (see FIG. 5).

That is, when driving is performed in the EV mode in Park or Neutral, the hydrogen fuel cell is temporarily turned on to compensate for the decrease in battery SoC, and accordingly, the hydrogen fuel cell output is variably controlled within the optimal efficiency line.

For example, in summer, while idling in Park, when the vehicle is stopped for several minutes to several hours with the A/C running, the hydrogen fuel cell output is variably controlled to reach the set SoC of 50% corresponding to P1 before entering the hybrid driving region in the EV driving region, and when the set SoC is reached, the control is terminated by turning off the hydrogen fuel cell (see FIG. 5).

In the past, no output has been generated due to non-operation of the hydrogen fuel cell in the EV driving region, but in the present embodiment, a control operation is performed to turn on the hydrogen fuel cell so that a predetermined stack output amount is generated at a level that reaches the set SoC, so that the variable stack output amount at this time may be compensated according to a decrease in battery SoC.

In addition, in preemptively performing efficiency priority control as described above (S610), when it is determined that the current SoC is continuously decreasing compared to the set SoC, charging priority control is performed with the second stack output amount higher than the first stack output amount (S620) (see FIG. 2).

For example, when the high-load output withdrawal condition such as V2L operation occurs in a state in which hydrogen fuel cell output variable control has started with SoC 50% optimal efficiency line to compensate for the target SoC for the decrease in battery SoC as described above in driving in the EV mode in Park or Neutral gear, the SoC continues to decline due to insufficient SoC compensation output at a start point of efficiency priority control of SoC 50%, and the SoC line moves from 50% to 40%. Accordingly, control is performed in a region outside an optimal efficiency region corresponding to P1 to achieve charging priority hydrogen fuel cell output (see FIG. 6).

Here, when the battery SoC, which has been reduced to 40%, is increased to 50% by output variable control according to the hydrogen fuel cell being turned on, the hydrogen fuel cell output is varied to follow the SoC 50% optimal efficiency line, and the control is terminated by turning off the hydrogen fuel cell when the target SoC is reached.

Meanwhile, the gear position is checked (S400), and depending on whether the gear is Drive or Reverse, on/off of the hydrogen fuel cell is controlled to determine the stack variable output to compensate for the required vehicle output amount and the difference between the target SoC and the current SoC (S500'), and accordingly, efficiency priority control or charging priority control is performed.

In this instance, efficiency priority control is preemptively performed (S630), and by this efficiency priority control, the hydrogen fuel cell is turned on so that the current SoC reaches the set SoC, which is set as the lowest SoC for turning the hydrogen fuel cell on/off. When the current SoC reaches the set SoC according to the first stack output amount, the hydrogen fuel cell is turned off (see FIG. 7).

That is, during driving in the EV mode in Drive gear or Reverse gear, for example, during low-speed creep driving, etc., a control operation is performed to temporarily turn on the hydrogen fuel cell to compensate for the battery SoC drop. Accordingly, the hydrogen fuel cell output is variably controlled within the optimal efficiency line, for example, the hydrogen fuel cell output corresponding to P1 is variably controlled to reach the set SoC of 50%. When the set SoC is reached, control is terminated by turning off the hydrogen fuel cell (see FIG. 7).

In addition, in preemptively performing the efficiency priority control as described above (S630), when it is determined that the current SoC is continuously decreasing compared to the set SoC, the charging priority control is performed with the second stack output amount higher than the first stack output amount (S640) (see FIG. 2).

For example, the vehicle is continuously driven in the high-load mode in Drive gear or Reverse gear, and when the vehicle stops in a state in which the battery SoC continues to drop, that is, when the battery SoC drops from the target SoC of 60% to 20%, 40% of the SoC needs to be compensated. Therefore, variable control of the hydrogen fuel cell output starts based on a line corresponding to P1 higher than that during output priority control of S620 by turning on the hydrogen fuel cell (see FIG. 8).

Here, in variably controlling the hydrogen fuel cell output variably to reach the set SoC of 50%, the control is terminated by turning off the hydrogen fuel cell when the set SoC is reached.

The present disclosure has an effect of being able to increase fuel efficiency and improve a driving range of a hydrogen electric vehicle having a hybrid structure including a hydrogen fuel cell and a high-voltage battery by enabling driving in an optimal efficiency region taking into account operation efficiency of a hydrogen fuel cell system and energy path loss of the high-voltage battery through an SoC control strategy for the high-voltage battery.

Accordingly, the present disclosure has an effect of improving marketability of hydrogen electric vehicles that lack charging infrastructure.

Even though the present disclosure above has been described with reference to the embodiment(s) illustrated in the drawings, these are merely exemplary, and those skilled in the art will understand that various modifications may be made therefrom, and that all or part of the described embodiment(s) may be selectively combined and configured. Accordingly, the true technical protection scope of the present disclosure should be determined by the technical idea of the appended claims.

What is claimed is:

1. A system for controlling a state of charge (SoC) of a battery of a hydrogen electric vehicle, the system comprising:
a control mode determination unit configured to monitor a current SoC for required vehicle output in a hybrid driving mode, compare the current SoC with a target SoC, and determine variable stack output of a hydrogen fuel cell for charge control or discharge control; and
a forced charging determination unit configured to monitor a current SoC for required vehicle output in an EV driving mode, compare the current SoC with a target SoC, control on/off of the hydrogen fuel cell for forced charging in response to a set driving condition satisfied, and determine variable stack output of the hydrogen fuel cell for efficiency priority control or charging priority control to follow a set SoC.

2. The system of claim 1, wherein the forced charging determination unit comprises:
a first forced charging determination unit configured to control on/off of the hydrogen fuel cell according to whether the hydrogen electric vehicle is in a Park gear or a Neutral gear so that efficiency priority control or charging priority control is performed; and
a second forced charging determination unit configured to control on/off of the hydrogen fuel cell according to whether the hydrogen electric vehicle is in a Drive gear or a Reverse gear so that efficiency priority control or charging priority control is performed.

3. The system of claim 2, wherein the first forced charging determination unit performs a control operation to turn on the hydrogen fuel cell so that the current SoC reaches the set SoC set as a lowest SoC for turning on/off the hydrogen fuel cell by the efficiency priority control, and performs a control operation to turn off the hydrogen fuel cell based on the current SoC reaching the set SoC according to a first stack output amount.

4. The system of claim 2, wherein the first forced charging determination unit causes the efficiency priority control to be preemptively performed, and causes the charging priority control to be performed with a second stack output amount that is higher compared to a first stack output amount that is based on the current SoC being determined to continuously decreasing below the set SoC.

5. The system of claim 4, wherein the first forced charging determination unit performs a control operation to turn off the hydrogen fuel cell based on the current SoC reaching the set SoC in response to the charging priority control being performed with the second stack output amount.

6. The system of claim 2, wherein the second forced charging determination unit performs a control operation to turn on the hydrogen fuel cell so that the current SoC reaches the set SoC set as a lowest SoC for turning on/off the hydrogen fuel cell by the efficiency priority control, and performs a control operation to turn off the hydrogen fuel cell based on the current SoC reaching the set SoC according to a first stack output amount.

7. The system of claim 2, wherein the second forced charging determination unit causes the efficiency priority control to be preemptively performed, and causes the charging priority control to be performed with a second stack output amount that is higher compared to a first stack output amount that is based on the current SoC being determined to continuously decreasing below the set SoC.

8. The system of claim 7, wherein the second forced charging determination unit performs a control operation to turn off the hydrogen fuel cell based on the current SoC reaching the set SoC in response to the charging priority control being performed with the second stack output amount.

9. The system of claim 1, wherein the control mode determination unit compares the current SoC with the target SoC, and causes discharge control to be performed according to an efficiency line set as an optimal stack output amount for discharge compared to the required vehicle output according to the SoC based on the discharge control being required.

10. The system of claim 1, wherein the control mode determination unit compares the current SoC with the target SoC, and causes charge control to be performed according to an efficiency line set as an optimal stack output amount for discharge compared to the required vehicle output according to the SoC based on the charge control being required.

11. A method of controlling an SoC of a battery of a hydrogen electric vehicle, the method comprising:
a driving mode determination step of determining whether a vehicle state is a hybrid driving mode or an EV driving mode through operation of a hydrogen fuel cell;
an SoC maintenance step of monitoring a current SoC for required vehicle output in response to determining that the vehicle state is the hybrid driving mode, comparing the current SoC with a target SoC, determining variable stack output of a hydrogen fuel cell for charge control or discharge control through a control mode determination unit; and performing SoC control with the determined stack output; and
an SoC forced charging control step of monitoring a current SoC for required vehicle output in response to determining that the vehicle state is the EV mode, comparing the current SoC with a target SoC, controlling on/off of the hydrogen fuel cell for forced charging in response to a set driving condition satisfied, determining variable stack output of the hydrogen fuel cell for efficiency priority control or charging priority control to follow a set SoC through a forced charging determination unit, and performing SoC control with the determined stack output.

12. The method of claim 11, wherein the SoC forced charging control step comprises:
a first forced charging determination step of controlling on/off of the hydrogen fuel cell according to whether the hydrogen electric vehicle is in a Park gear or a Neutral gear so that efficiency priority control or charging priority control is performed; and
a second forced charging determination step of controlling on/off of the hydrogen fuel cell according to whether the hydrogen electric vehicle is in a Drive gear or a Reverse gear so that efficiency priority control or charging priority control is performed.

13. The method of claim 12, wherein the first forced charging determination step comprises performing a control operation to turn on the hydrogen fuel cell so that the current SoC reaches the set SoC set as a lowest SoC for turning on/off the hydrogen fuel cell by the efficiency priority control, and performing a control operation to turn off the hydrogen fuel cell based on the current SoC reaching the set SoC according to a first stack output amount.

14. The method of claim 12, wherein the first forced charging determination step comprises causing the efficiency priority control to be preemptively performed, and causing the charging priority control to be performed with a second stack output amount that is higher compared to a first stack output amount that is based on the current SoC being determined to continuously decreasing below the set SoC.

15. The method of claim 14, wherein the first forced charging determination step comprises performing a control operation to turn off the hydrogen fuel cell based on the current SoC reaching the set SoC in response to the charging priority control being performed with the second stack output amount.

16. The method of claim 12, wherein the second forced charging determination step comprises performing a control operation to turn on the hydrogen fuel cell so that the current SoC reaches the set SoC set as a lowest SoC for turning on/off the hydrogen fuel cell by the efficiency priority control, and performing a control operation to turn off the hydrogen fuel cell based on the current SoC reaching the set SoC according to a first stack output amount.

17. The method of claim 12, wherein the second forced charging determination step comprises causing the efficiency priority control to be preemptively performed, and causing the charging priority control to be performed with a second stack output amount that is higher compared to a first stack output amount that is based on the current SoC being determined to continuously decreasing below the set SoC.

18. The method of claim 17, wherein the second forced charging determination step comprises performing a control operation to turn off the hydrogen fuel cell based on the current SoC reaching the set SoC in response to the charging priority control being performed with the second stack output amount.

19. The method of claim 11, wherein the SoC maintenance step comprises comparing the current SoC with the target SoC, and causing discharge control to be performed according to an efficiency line set as an optimal stack output amount for discharge compared to the required vehicle output according to the SoC based on the discharge control being required.

20. The method of claim 11, wherein the SoC maintenance step comprises comparing the current SoC with the target SoC, and causing charge control to be performed according to an efficiency line set as an optimal stack output amount for discharge compared to the required vehicle output according to the SoC based on the charge control being required.
